(19) United States
(12) Patent Application Publication
(10) Pub. No.: US 2020/0371547 A1
(43) Pub. Date: Nov. 26, 2020

(54) Wearable Smart Device

(71) Applicant: Affan Arshad, Elk Grove, CA (US)

(72) Inventor: Affan Arshad, Elk Grove, CA (US)

(21) Appl. No.: 16/989,885

(22) Filed: Aug. 11, 2020

Related U.S. Application Data
(63) Continuation-in-part of application No. 16/663,165, filed on Oct. 24, 2019, now Pat. No. 10,739,819.
Application No. 16/663,165 is a continuation-in-part of application No. PCT/IB2019/059155, filed on Oct. 24, 2019.
(60) Provisional application No. 62/750,104, filed on Oct. 24, 2018.

(51) Int. Cl. G06F 1/16; G04G 21/08; G06F 1/18

(52) U.S. Cl. CPC G06F 1/163; G06F 1/188; G04G 21/08

(57) ABSTRACT

A wearable smart device is configured to provide wireless and cellular data access through position- and orientation-adjustable touchscreens, which may be flexible or rigid and may be of a variety of different screen compositions. The device includes a Wristband, a primary touchscreen, a secondary touchscreen, a swiveling mechanism, a first ratcheting mechanism, and a controller. The wristband enables a user to connect the present invention to the user's body, especially around the user's wrist. The wristband can also house the power source. The primary touchscreen provides the user with the ability to interact with the device through touch. The secondary touchscreen also allows the user to further interact with the device. The swiveling mechanism enables the primary touchscreen to rotate upon the wristband. The first ratcheting mechanism enables adjustment of the secondary touchscreen relative to the primary touchscreen. The controller accepts electrical inputs and returns electrical output signals. A portable power supply is positioned offset from the controller.

The current application claims a priority to the U.S. Provisional Patent application Ser. No. 62/750,104 filed on Oct. 24, 2018.

This application is a CIP child application for non-provisional utility application Ser. No. 16/663,165

### FIELD OF THE INVENTION

The present invention generally relates to a smart device. More specifically, the wearable smart device relates to a watch with one or several touchscreen displays that can be adjustably oriented to improve comfort during use and adjust functionality. The device has power source outside the main housing on the strap. The power source is connected to the controller electrically.

### BACKGROUND OF THE INVENTION

Electronic devices have become an essential part of many people's lives. From smart phones to tablets and laptops, almost everyone carries an electronic device with them. Smart phones especially have grown in popularity over the last decade thanks to the various functionalities smart phones provide. In addition, with the continuing advances in technology, the shape and size of smart phones have been decreasing, allowing for better and more comfortable transportation and use. For example, while old phones were bulky and were not easily carried on a pocket, newer smart phones are slim, which enables users to carry and use the smart phones more comfortably. Currently, there has been a growing interest of providing smart phones or mobile computing devices as wearable devices. Many wearable devices are currently available, such as smart watches. However, the currently available wearable devices provide limited functionality due to the size restriction these devices have. Many of the currently available wearable devices are only able to provide data transmitted from a main device due to being unable to carry out the processes that the main device can. For example, many smart watches are mostly able to operate as long as the smart watches are connected to a smart phone. Thus, the functionality of many wearable devices is dependent on the connection to a main device. Some wearable smart phone devices have been disclosed which try to provide a smart phone which can be carried on the body of a user. However, these wearable smart phone devices are not practical to be used while the users wear these devices on the body. Also these devices house the battery under the screen with the electronics in the main housing of the device. Thus, there is a need for a wearable smart phone which eliminates the shortcomings of previous wearable computing devices. An objective of the present invention is to provide a smart phone or a wearable smart phone that has main power source outside the main body of the device away from the electronic components and displays. The wearable smart phone comprises a structure designed to be worn on the body of the user, preferably around the wrist and power source is on the strap. The wearable smart phone comprises a flexible display with a bendable structure which can be rotated.

Further, a plurality of batteries can further be provided as removable/non removeable batteries for additional power to the wearable smart phone. The battery can be either hard segmented battery connected to each other via electrical connection around the wristband or could be a one piece bendable/flexible battery wrapped on the wristband.

### BRIEF DESCRIPTION OF THE DRAWINGS

FIG. 1 is a side view of the present invention with segmented battery on strap.

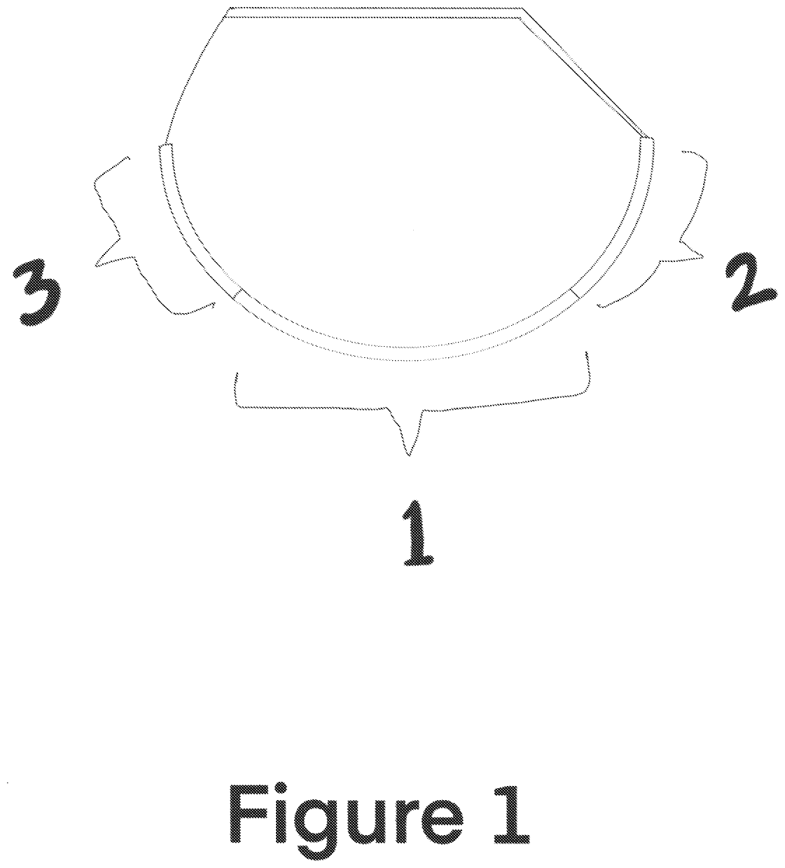

FIG. 2 is a side view of the present invention with bendable one-piece battery on strap.

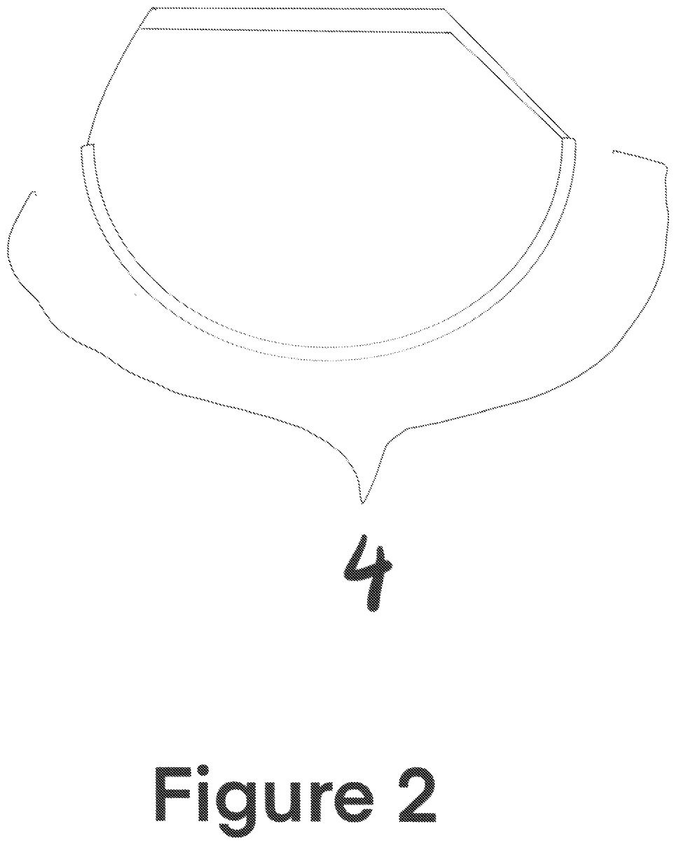

### DETAILED DESCRIPTION OF THE INVENTION

All illustrations of the drawings are for the purpose of describing selected versions of the present invention and are not intended to limit the scope of the present invention.

The present invention is a wearable smart device that is used to enable a user to access the internet and applications with associated user accounts through cellular data or Wi-Fi. The present invention is configured to provide The wristband relates to a flexible polymeric strap that enables a user to connect the present invention to the user's body, especially around the user's wrist. This wristband also has the power source in it which can be removeable.

Although the invention has been explained in relation to its preferred embodiment, it is to be understood that many other possible modifications and variations can be made without departing from the spirit and scope of the invention as hereinafter claimed.

What is claimed is:

1. A wearable smart device comprises:
a power source that is outside the main housing of the device;
the power source being integrated into the wristband;
the power source being positioned opposite to the primary touchscreen about the wristband;
and power source being electrically connected to the primary touchscreen, the secondary touch screen, and the controller.
